(19) United States
(12) Patent Application Publication
(10) Pub. No.: US 2023/0260024 A1
(43) Pub. Date: Aug. 17, 2023

(54) Method, Apparatus and System for Social Network for Investment with a Desktop and Mobile Based Messaging Platform

(71) Applicant: Shalabh Saxena, Fremont, CA (US)

(72) Inventor: Shalabh Saxena, Fremont, CA (US)

(21) Appl. No.: 17/670,452

(22) Filed: Feb. 12, 2022

(51) Int. Cl. G06Q 40/04; H04L 51/52; G06F 16/9536

(52) U.S. Cl. CPC G06Q 40/04; H04L 51/32; G06F 16/9536; G06N 20/00

(57) ABSTRACT

A dedicated social network for investment, financial news and information framework method, apparatus and system is presented. Users have the ability to include one another in their financial network, exchange financial news cards, assimilate and synthesize knowledge on stock and securities trading. Machine learning based algorithms for search and sort are used. Framework also provides within itself to invoke the trading platform to effectuate trades with appropriate exigency. Active investors and sightseers are participants, such that through their read preferences a mechanism is provided to be able to evaluate and measure the efficacy and accuracy of the news being shared on the financial network.

### FIELD OF THE INVENTION

The present invention relates generally to provision of a mobile or desktop based platform for financial transactions and trading. More specifically, the present invention proposes a method, apparatus and system for a user to avail of a framework to trigger his or her new or already existing social network to share and exchange information and news on financial trading instruments, make informed decisions and if necessary, trigger and effectuate trade of the securities of interest within the framework.

### BACKGROUND OF THE INVENTION

This algorithmic framework is a decision support tool to help a user select better or optimal choices based on his/her trading needs. In the modern world, choices are getting increasingly complicated and too often users do not have the knowledge or expertise to make the selections best suited for their needs, goals and financial objectives. Good examples are stocks, bonds mutual funds, insurance, housing, automobiles, consumer durables, medical equipment and healthcare facilities. Present invention seeks to create expertise synergies and sharing mechanism regarding financial instruments trading.

When people meet at a social event, usually after a short span of time, they start to talk about investments. Whereas they may not actually invest, they invariably talk about it. More often than not, such talk deals with discussions of particular stocks, market news, upside and downside discussions and perceived and or actual reasons behind the market price fluctuations. While investments are a topic of interest in face to face conversations, most people do not communicate about investment through mobile and/or web platforms, such as Facebook, Google Hangouts and WhatsApp etc. These are attributed to several reasons. First, financial news sharing and investing conversations are not welcome on these platforms. Second, for the purposes of the conversation, ice breaker from a legitimate and credible source is needed, rather than merely an unsubstantiated opinion. As an illustration, a stock group on WhatsApp usually dies in less than two months according to surveyed data. A number of persons, who are not primarily interested in financial transactions, but participate broadly in social network become mere sightseers and do not contribute to information gather and exchange. Current solutions, which are available, neither take a user's needs and preferences into account nor provide detailed analysis or recommendations solely for the purposes of financial news and transactions, they are general purpose platforms. Platforms like Facebook, LinkedIn, Twitter, Instagram, Snapchat are not focused on financial aspects and are mostly for impromptu and informal information exchange purposes. Closest comparison to financial social network under current solutions are WhatsApp and Stocktwits. WhatsApp suffers from the shortcomings that users do not prefer to share financial news, rather wish to be restricted to informal information sharing or fun. The news sharing and reading is not built into WhatsApp, but rather link based accesses require leaving the app. There is no notion of trending financial news, it is a general platform. Stocktwits on the other hand is not trusted network. There is no policing, so anyone can say anything and legitimate source news is wanting. Users are not disciplined or focused on a common purpose to trade financial securities. Similar to WhatsApp, Stocktwits also does not have a crowdsourced and ordered newsfeed, only peoples' opinions are shared. None of these options take a user's needs fully into account or provide analysis and appropriate recommendations for stock and or securities trading.

There are many social networks, like Facebook, LinkedIn or Twitter. Each one of these has attained a specific purpose like friends' status, career updates and political news. While these social networks have similarity of material sharing, they are perceived in a specific manner. As an example, users do not preferably go to Facebook to update their career information. The primary reasons for such social network boundaries are driven by the expectations of the receiver. If a particular social network does not welcome a career update, then sender will eventually stop posting career updates and user interest boundary (segmentation) is created, say between Facebook and LinkedIn.

Presently, social network of investment does not exist. This is evident from the fact that none of the financial news website have a dedicated share button which can share the news on a network, where it is expected and welcome to be received. Most financial sites like seekingalpha.com, benzinga.com are using arbitrary share buttons, which are not used by everyone. One of the named websites, attempts to share by general purpose email, where the news may not be welcome and may be receiver specific as to its interest. So there is a need for a social network where in users can discuss the financial news and share them freely, as the same is welcome expected and desired in this dedicated network.

The problem of “decision support through optional social network sharing and exchanging trending financial news for optimal selection of financial instruments by end user” solves the problem. While many solutions are feasible, the emphasis is on creating a solution which is simple, effective, user friendly and which would be applicable across many products and services with focus on financial trading of securities, mutual funds and bonds. This invention presents a solution for these issues and has the sought benefits.

### BRIEF DESCRIPTION OF THE DRAWINGS

FIG. 1 is one embodiment of a system diagram illustrating the invention. It shows a proposal that a social network is overlaid over the internet framework to be able to disseminate, share, and engage in public discourse over financial trading instruments. The figure also shows a trading platform, where various computers running internet are connected to trading system computer systems which in turn access the trading exchange.

FIG. 2 is one embodiment in an exemplary way of a mobile or desktop application with a screen display showing receipt of news cards from a plurality of senders when notification from the proposed app are enabled on the cellphones.

FIG. 3 is one embodiment in an exemplary way of a mobile or desktop application screenshot obtained after pressing the “SEND” button on a financial news card in the transmit mode. It displays a whole list of persons obtained in one embodiment from a user's contact list, from where a list of persons can be chosen to whom the news card of interest is to be sent.

FIG. 4 is one embodiment in an exemplary way of a mobile or desktop screenshot of a chat participant receiver who has received two financial news cards over a course of about three hours and has chatted and is getting ready to send and initiate a news card of his/her own. The figure shows the social network overlaid over the internet being in play.

FIG. 5 is an exemplary embodiment of a mobile or desktop screenshot where the sender on the social network accesses chat news, where a news about carmaker TESLA is shared. The user converts the chat news as a financial news card, which is ready to be shared and sent. Stock symbol TSLA is displayed to be used as a link to access market parameters for the stock, all of which are provided by the app.

FIG. 6 is one embodiment of a mobile or desktop application screenshot of a recipient participant of the social network proposed, here older news cards, along with the newly received TESLA news card is displayed. Also, it is overlaid with a new TESLA stock icon, showing the stock market parameters and further options to be able to read more or effectuate a trade.

FIG. 7 is one embodiment of a screenshot of a mobile or desktop application of a sender where user has chosen the “SEND” button from the news card, it displays the user to whom the news card would be sent, further a scheme is provided to name additional stocks with a prepend of the “$” sign and to be able to share additional research (associate news to stock(s)) and news material for a new related or unrelated stock. It also shows that once the type window is chosen, a keyword to be able to type.

FIG. 8 is an exemplary embodiment of a screenshot of a mobile or desktop showing a chat session, with two juxtaposed windows or screen split, with one showing a list of all possible users from a contact list and an active chat session with a named user, where the news cards are sent, along with communication from both sides. This application is built over the social network proposed dedicated to the financial news exchange and discussions.

FIG. 9 is an exemplary embodiment of a screenshot of a mobile or desktop the entire flow executed by the app or framework, starting from news obtained from the relevant financial sites, invoking the app through sharing or explicit call, showing the “SEND” screen, with relevant news cards, the receiver's corresponding screen, with the LYFT news card received, various options for the user and the user deciding to explore the stock LYFT for forming his/her own opinion, doing further research or to be further sender or sharer of the news on the proposed social network.

FIG. 10 is an exemplary embodiment of a screenshot of a mobile or desktop showing access of the financial news, receipt of financial news cards, and the ability to share the same on a variety of apps, including the one that has been proposed.

FIG. 11 is an exemplary embodiment of a screenshot of a mobile or desktop showing the send menu for the news card to be disseminated with all or individualized persons on the contact list.

FIG. 12 is an exemplary embodiment of a screenshot of a mobile or desktop showing a plurality of news cards, with appropriate menus to be able to send and share them with a plurality of persons in the contact list. Among four possibilities, the trending prong is chosen, with corresponding news cards shown.

FIG. 13 is an exemplary embodiment of a screenshot of a mobile or desktop showing a plurality of news cards, with appropriate menus to be able to send and share them with a plurality of persons in the contact list. Among four possibilities, the “most read” prong is chosen, with corresponding news cards shown.

FIG. 14 is an exemplary embodiment of a screenshot of a mobile or desktop showing a “WATCHLIST” screen derived from the home screen. User can get all relevant updates of stocks placed on the watch list.

FIG. 15 is an exemplary embodiment of a screenshot of a mobile or desktop showing the derived screen when “SHARE” button is chosen from the home screen. User gets ability to choose a single or group chat to disseminate financial news cards.

FIG. 16 is an exemplary embodiment of a screenshot of a mobile or desktop showing the derived screen when “ANALYTICS” button is chosen from the home screen. User gets ability to see information on a number of stocks chosen from being trending, preset, or market most active, among others. Click on histograms takes to all relevant financial news cards.

FIG. 17 is an exemplary embodiment of a screenshot of a mobile or desktop showing “MARKET MOVERS” screenshot, superimposed over the news card screen. Market parameters are displayed for various indices, along with top gainers and losers with pointers to trade through stock symbols.

FIG. 18 is an exemplary embodiment of a screenshot of a mobile or desktop showing a plurality of news cards, with appropriate menus to be able to send and share them with a plurality of persons in the contact list. Among four possibilities, the bookmark prong is chosen, with corresponding news cards shown.

FIG. 19 is an exemplary embodiment of a screenshot of a mobile or desktop showing a plurality of news cards, with appropriate menus to be able to send and share them with a plurality of persons in the contact list. Among four possibilities, the “latest” prong is chosen, with corresponding news cards shown.

### DETAIL DESCRIPTIONS OF THE INVENTION

All illustrations of the drawings are for the purpose of describing selected versions of the present invention and are not intended to limit the scope of the present invention.

In the following description specific details are set forth describing certain embodiments. It will be apparent, however, to one skilled in the art, that the disclosed embodiments may be practiced without some of these entire specific details. The specific embodiments presented are meant to be illustrative, but not limiting. One skilled in the art may realize other material that, although not specifically described herein, is within the scope and spirit of this disclosure. For purposes of this disclosure, proposed framework system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, framework system may be a hardware device of size, shape, performance, functionality, and price. In another embodiment, it may comprise of software components capable of being loaded to run on a hardware device. The framework system may include random access memory (RAM), one or more processing resources such as a central processing unit (CPU) or hardware or software control logic, read only memory (ROM), and/or other types of nonvolatile memory. Additional components may include one or more disk drives, one or more network ports for communicating with external devices as well as various input and output (I/O) devices, such as a keyboard, a mouse, and a video display. The framework system may also include one or more buses operable to transmit communications between the various hardware components. The framework system may be dedicated system of hardware and software. In another embodiment, it may constitute transferable software code loadable and runnable on a general purpose computer system.

Software, in accordance with the present disclosure, such as program code and/or data, may be stored on one or more machine readable mediums, including non-transitory machine readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

This is a information sharing framework to help a user decide which option/choice is best suited for his/her purposes, from a multitude of such options or choices to buy financial instruments which may be available. The analysis of each option to buy is based on information received and transmitted to a plurality of social network participants who have earlier indicated their consent to send and receive financial news information. The tool is dynamic in nature. More options as well as user-inputs can be added to the tool to make it more sophisticated over time. In this embodiment, the framework system is used for disseminating, receiving, consolidating financial instruments news, assimilating it and then if appropriate and so deemed, invoking the embedded trading frameworks to be able to effectuate the trades. In another embodiment, it may be used for disseminating, receiving, sending and sharing of regular insurance, choice of mutual funds, housing, automobiles, consumer durables, medical equipment and healthcare facilities. The benefits provided, in one embodiment include ability to send financial news card to ones' social network in chat or otherwise and title in notifications through web and mobile platforms with an underlying link to trading sites. In another embodiment, the framework provides a connection of financial news websites to discussion with acquaintances, finding trending news and using it for stock trading. The framework therefore provides for social network for financial news with the ability to trade the stocks. The always connected present world needs community of investors chatting with each other on mobile and desktop platforms. In the community of investment, some people talk actively about investment and some are just sightseers engaged in listening only. A social network is needed to address these two categories of persons. This invention connects the active investors as well as provides most trending, latest, most read or bookmarked news to sightseers. The framework provides a sightseer to turn into an active trader, based on the information exchanged, studied and assimilated.

In one embodiment, a new data structure driven windowlet screen shot is proposed which serves as the unit of information shared between users. A “news card” is an entity comprising of a display financial news title; ability to read the news details after clicking the news title; display of news source website information; associate stocks with its current market value, market value at the time of financial news card was sent and daily change; ability to quick connect with stock specific trending, latest, most read news; ability to add or remove stocks to and from watch list; provide quick ability of trading stock and financial instrument with a launch to financial applications; ability to send and share the financial news card with social network; ability to display count/order of news for “trending news” and “most read news” and time stamp for the “latest news”; ability to bookmark the news card; ability to provide news card notification with news title to social network with the username; ability to associate or remove stocks to news card and add or update or delete comments to news card.

This framework system provides workflows of connecting the financial news sites to news sharing with friends in chat and title in notifications through desktop or mobile platforms. In other words, a dedicated social network is proposed solely for financial news and trading. The framework provides ability to connect the stocks during sharing, launch a stock trading website to convert news to stock buying, ability to trend the news based on the sharing, suited for passive reader and ability to highlight most read news, latest news, and bookmarked news, also suited for passive reader analysis.

In one embodiment, this invention describes a method, apparatus and system to bridge financial news to trading website. The publication of financial news on different websites impacts the market and the stock value. Users who may be investors read this news and analyze the current stock price, deduce the future price most often discussing with their network participants. There is social network available like LinkedIn for career, Facebook for friends and WhatsApp for communications. Similarly, a dedicated network where in people can talk to their friends for the investment discussions which sources and is based on financial news from the appropriate websites is proposed. This has ability to exchange peer to peer (or peer to expert even) financial news cards on mobile and desktop with associated stocks and comments. Whereas the news sharing may be common, a peer to peer financial news sharing on hitherto unavailable social network platform is a distinction for a financial news sharing.

The framework can be used for various products and services as well as implemented using different technologies. In one embodiment the framework system can be focused on financial news sharing. In another embodiment the framework system can be used on stocks related to a particular segment. In yet another embodiment, it can be used for right and properly priced sector selection and then for particular financial instruments.

In one embodiment, the proposed invention is implemented through a desktop or mobile based app likely to be named “Opiniontrade” which provides for exchange and dissemination, assimilation of financial news cards with functions of sending title of the news in notifications to another user; sending title of the news in notifications to multiple users with selection through check boxes; sending title of the news in the notification groups; showing title of news in notifications; showing associated stocks; ability to read the news from the title of news; provision of stock button showing the details and ability to launch other apps; comments of user, add the new stock name with $name of stock; ability to send mobile notification from web to mobile with above functionalities.

In one embodiment, this framework suggests financial news cards as entity which is comprising of but not limited to displaying financial news title, ability to read the news details after clicking the news title, display news source website information, associated stocks with its current market value, market value at the time of financial news card was sent and daily change; ability to quickly connect with stock specific trending, latest, most read financial news is provided; ability to add or remove stocks to or from watchlist. The financial news card also provides quick ability of trading stock or other financial instrument with a launch to financial application; ability to create an entity as a financial news card and send and share the financial news card with social network; ability to display count/order of news for trending news and most read news and time stamp for the latest news based on machine learning algorithms; ability to bookmark the news card for future reference; ability to provide news card notification with news title for this social network for investment with the username; ability to associate or remove stocks to news cards; and add or update or delete comments to news card.

In one embodiment, faster rendering of screen is achieved as the framework is optimized by modifying the native modules to load individual listener for every stack of news screen rendering, thus increased the performance of application by 4 times. Performance enhancement is achieved by loading of screen behavior as the framework introduces a custom built loading mechanism where in individual text will be shown as loading, resulting in end user feeling with better performance.

In another embodiment, faster chat loading is achieved through asynchronous call to backend system provides faster loading of chat summary. Details are fetched on specific chat loading. This has been achieved based on RAM format enablement where in memory is allocated in an advanced specific manner. In one embodiment, search algorithms are designed to retrieve information from local framework cache before it goes to server value retrieval, resulting in most cases search available at faster speed. In stock association to news, stock association to news is done at server level, resulting in faster association and quick retrieval of news and stock association. In another embodiment for watch list news display, stocks associated to watch list shows news related to watch list stocks only. Performance is optimized by having limited information at mobile app while association check at server level with quick information retrieval. In one embodiment, asynchronous calls are used all around to display the needful data only for faster loading.

In one embodiment, application provides machine learning and algorithm-based ratings for investment news so that the end user can get “trending,” “most read” and “latest” financial news and stocks to make decision. Ordering of financial news are achieved by populating the data models from wide user base and subscriber base interactions for a specific financial news. This results in one end user quickly accessing the information which got rated and or selected by other users and subscribers of system. In one embodiment, the framework will be able to identify the most viral financial news of the day or over several days, which is of interest to user(s) who are notified. In this embodiment, framework will be able to find hot and viral news quickly through trending counts. User(s) who have chosen to be notified shall be notified promptly.

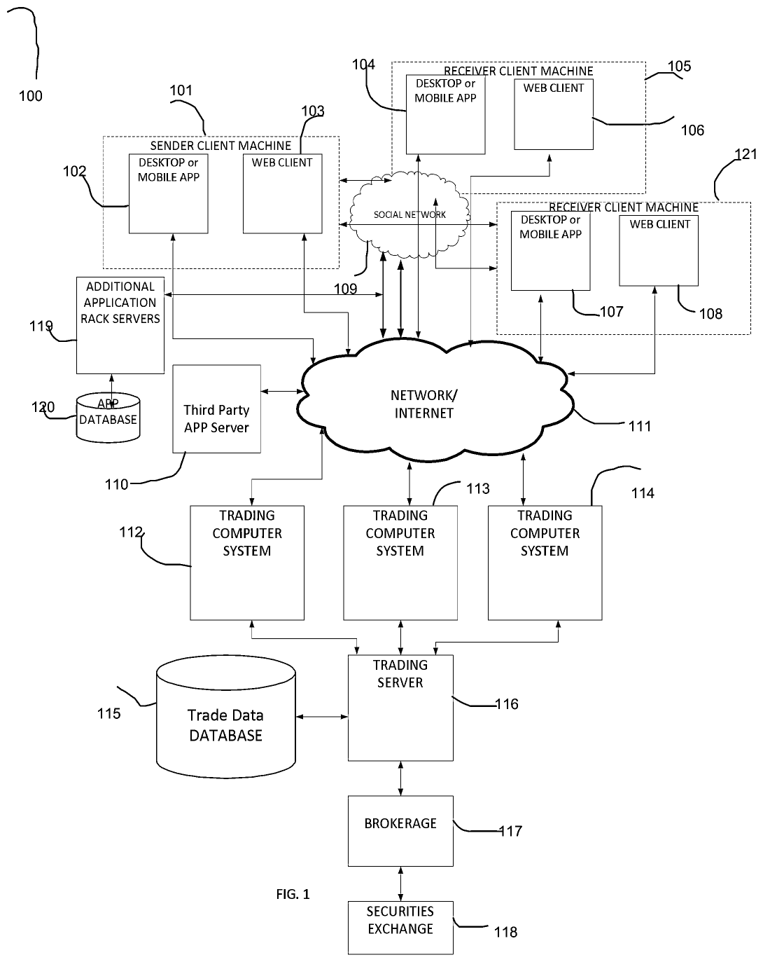

FIG. 1 100 is illustrative of a top level system diagram. Sender and receiver clients or users 101 105 121 are available on their respective client machines running a program 102 104 107 as well as a web client 103 108 106. This invention proposes a dedicated social network 109 for financial news card exchanges. Each of the sender and receiver user 101 105 121 communicates with other users 101 105 121 over this proposed new social network 109 for finances. Besides the social network 109, each of the user be it a sender or receiver 101 105 121 is in direct contact with an internet network 111. The new social network 109 is overlaid over the internet network 111. The internet network 111 is in turn connected to a plurality of third party application server 110, a plurality of trading computer systems 112 113 114 with their corresponding memory and processor. Each of the trading computer system 112 113 114 communicates with common or individual trading server 116, with its dedicated trade database 115. The trading server 116 is connected to a plurality of brokerages 117, which have ability to communicate with a securities exchange 118 for trading of financial instruments. Additional rack servers 119 and corresponding database 120 are accessible to users.

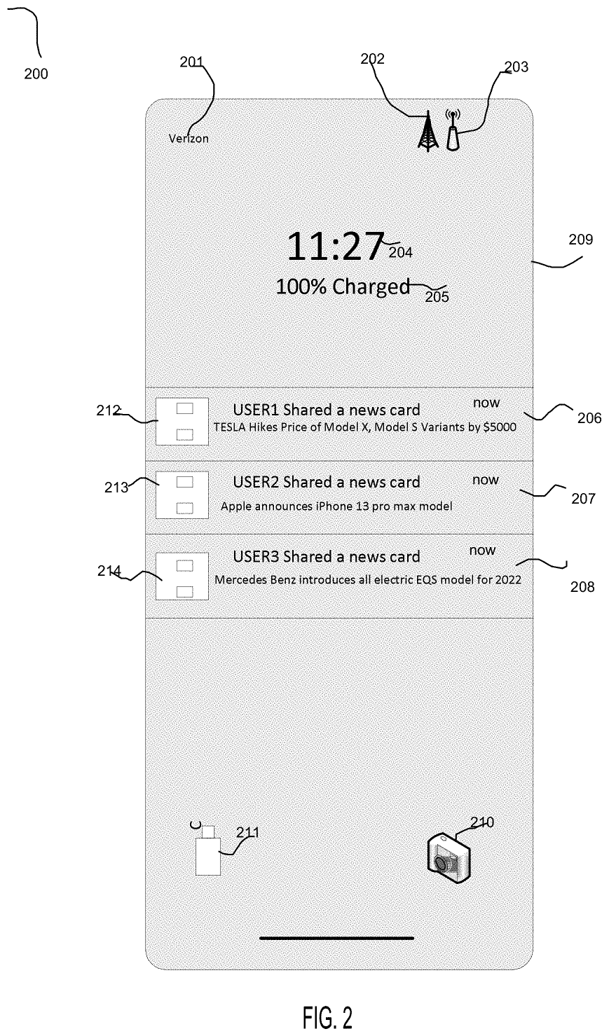

FIG. 2 200 illustrates as one embodiment of a mobile or desktop application screen shot 209 showing a service provider 201, availability of wifi 203 and wireless connection 202. The screen shot 209 shows receipt of a plurality of financial news cards 206 207 208 received from other users. The screen shot 209 shows current time 204 and amount of charge 205 available with the device 209. As a standard screen shot 209, the device provides a button to light a torch 211 and enable a camera 210. When enabled, notification on receipt of news cards and messages is provided 212 213 214.

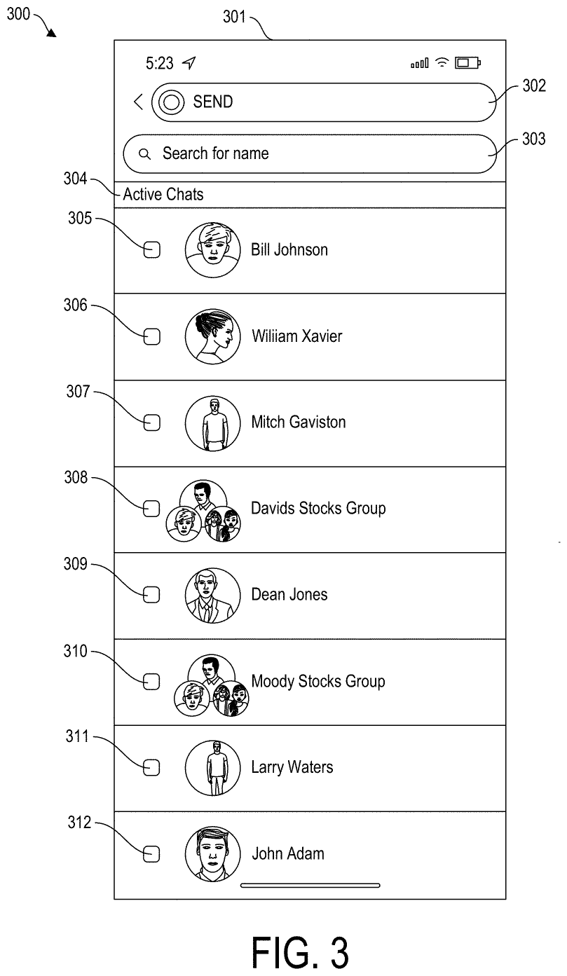

FIG. 3 300 is an exemplary illustration of a mobile or desktop application screen shot 301 showing that the sender user has chosen the “SEND” button 302 from a financial news card that then triggers listing of all possible recipients 305 306 307 308 309 310 311 312, with a list obtained from the user's contact list in one embodiment. User is provided a button to tick 305-312 to enable transmission to a plurality of recipients on the list 305-312. A type space window is provided to search users 303 from the list for speedy selection from an active chat 304. Also the “SEND” function window is triggered based on the choice by the user 302.

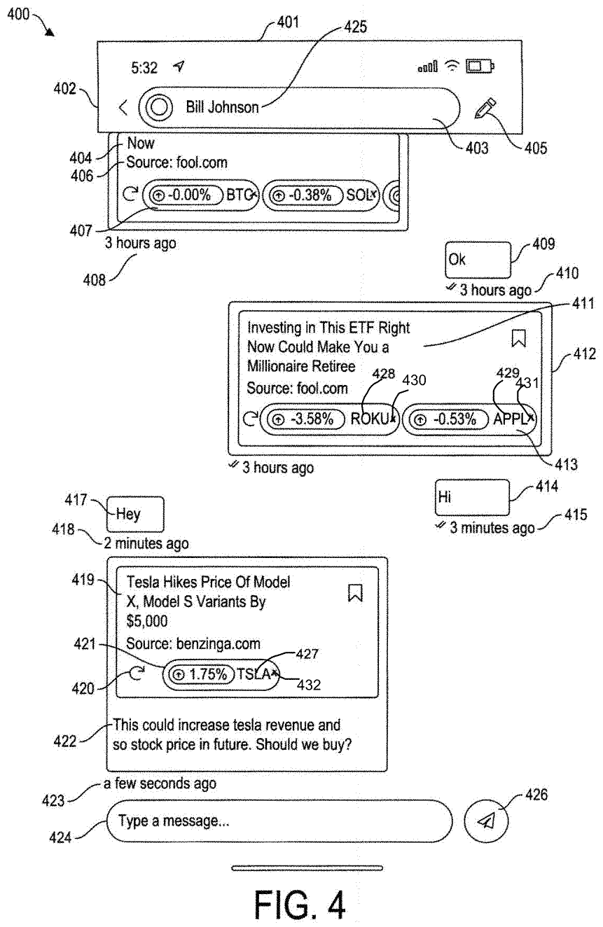

FIG. 4 400 is an exemplary illustration, in one embodiment, of a mobile or desktop application screen shot 401 for a particular named user 425. The left side is the initiator's half of the communication 417 418 423, while the right is the receiver side of the communication 414 415 412. A news card is shown received earlier 404 406 407 408 and a news card is also shown as recently received 419 421 420 422 423. A financial news card has a title 419 411, source of the news 406 and a list scannable of stocks 407 413 421 and other financial instruments including stocks 407 413 421 showing change in value and stock symbol. The appropriate buttons 420 within financial news card provide availability to research the stock 421 407, see its current market parameters. Part of the financial card receipt also relates the time when it was received 408. Besides the financial news cards, regular greetings and communication 422 is also shown on both sides 417 409 414. Each financial card gives ability to pass comments and opinions through typing 422 424. Comments of the sender are also displayed on receipt on receiver's chat transcript 422. Each stock symbol 427 428 429 shown provides a link to the trading site 421 and access to trading platform 421. Mechanism is provided to see sender details 405. Option to trade stock at financial application is provided 430 431 432.

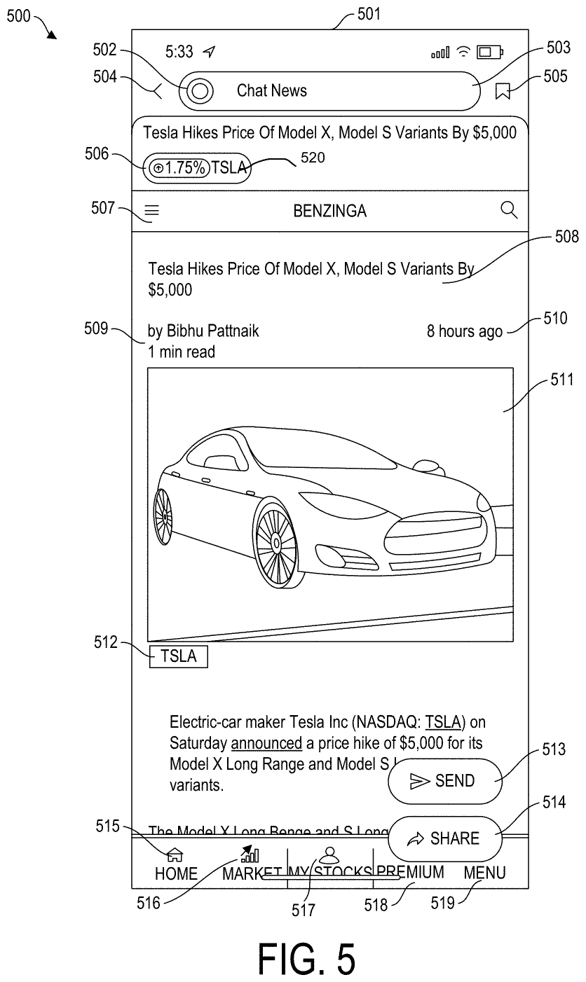

FIG. 5 500 is an exemplary illustration, in one embodiment, of a mobile or desktop application screen shot 501 showing initiation and acquisition of a financial news through chat 502 504. Within the application, user enables chat news 502 and by accessing BENZINGA website 507, as an exemplary illustration, accesses news about TESLA 506 508 509 510 and one of their models. The news gives access to TSLA stock 506 512, its present value 506, the time it will take to read the news 509, time it was posted 510, associated pictures. 511 In a superimposed way, “SHARE” 514 and “SEND” 513 buttons are shown to access to screen shot embodiments already described, particularly the screen shot associated with “SEND” 513 button. The app also gives linked access to app's home page 515, market 516, user's stocks 517, bonus or additional news through premium 518, and a MENU button to list all possible choices available to the user 519. There is provision 506 for stock details with a popup to find “trending,” “latest,” “most read news” and option to add or remove to and from watch list. There is also support to be able to trade stock at financial application 520 and get latest, trending and most read financial news for TSLA and add or remove stocks to and from watch list. User can also swipe right or left to read next news.

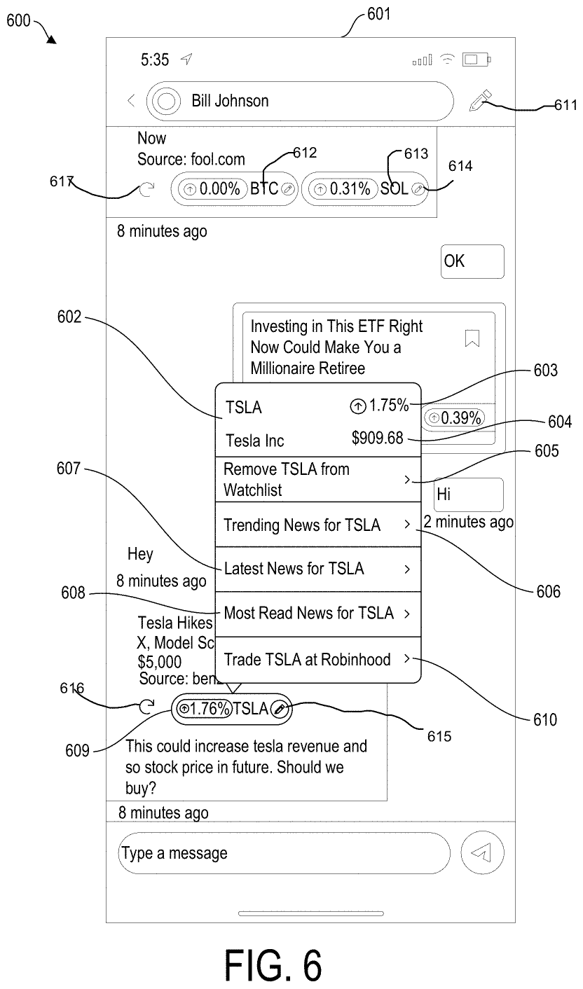

FIG. 6 600 is an exemplary illustration, in one embodiment, of a mobile or desktop application screen shot 601 showing a receiver's end of the app usage. The receiver receives a normal greeting, a financial news card received some time ago, and as an exemplary embodiment, the TESLA news card just received 609, after being extracted from a financial site and sent over by another user on the social network. User has pressed the TESLA stock further information link 609, so information on the stock is displayed on a superimposed window within the screen shot 602 607 608 603 604 605 606 610. The superimposed window gives additional options to user to add or remove TSLA stock to and from watch list 605, access trending news on TESLA 606, most read news (or latest news, trending or bookmarked) about TESLA 607 608 and an option to trade TESLA at a financial application 610 615. A specific icon is provided for it also 614. The financial news card on TESLA is also shown as received 609. Option is provided to access and get linked information for the stock at issue as well as all related stocks say within the same sector 609. A message type window is provided for user to further interact if needed, prior to initiating a trade, if that is desired. This figure is specifically focused on description of the superimposed window showing plethora of information available on any particular stock merely by pressing a button within the window. Ability to research current value of stock is provided 616 617.

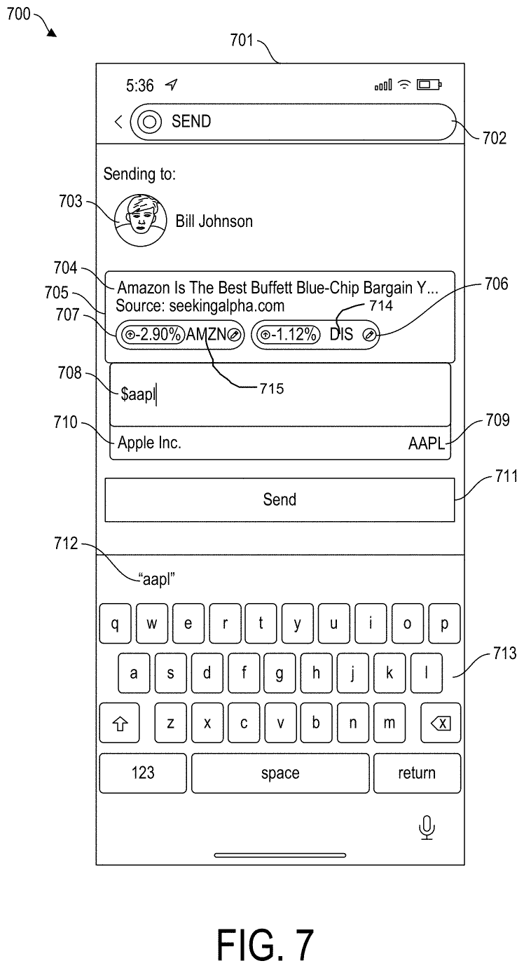

FIG. 7 700 is an exemplary illustration, in one embodiment, of a mobile or desktop application screen shot 701 showing a sender's end of the app usage 703. The sender chooses a receiver 703 from the available contact list as described on a previous window. The particular news card is synthesized in an exemplary way for AMZN related news 704 705 707 706. The news card has a title of news 704, pointer to AMZN stock 707 and other related stocks 706. Option is provided to type “$” and append any stock symbol 708 through invocation of a key board 712. By adding the new stock and sending it, 708 receiver can access all of the information associated with the “AAPL” stock in an exemplary way 708 710. An option is provided to input stock symbol and comments through voice also.

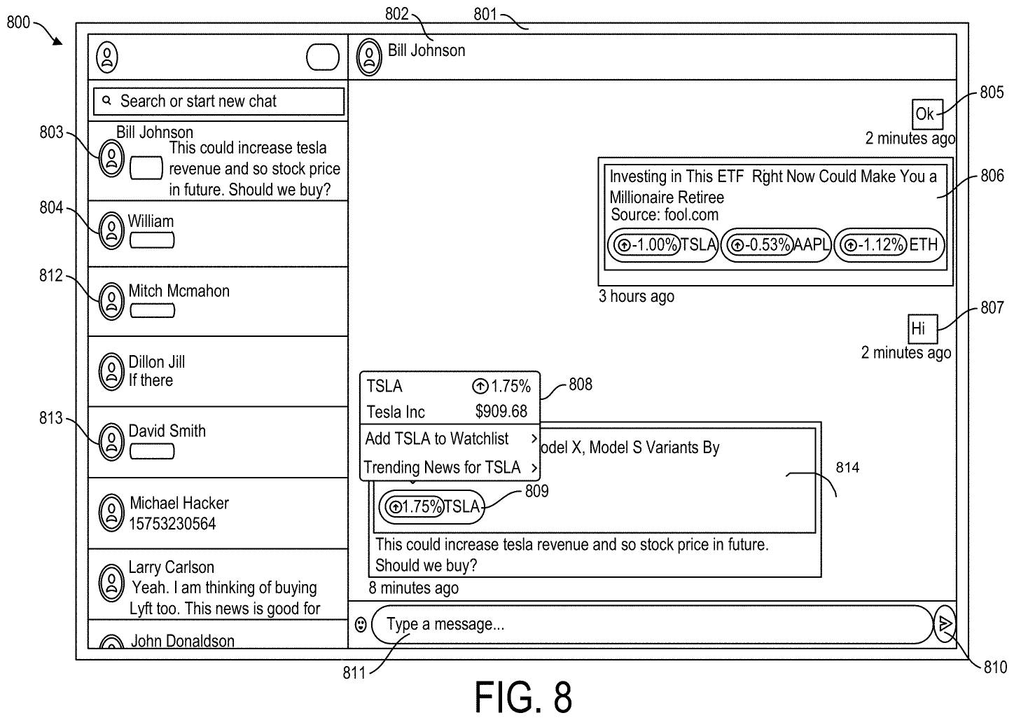

FIG. 8 800 is an exemplary illustration, in one embodiment, of a mobile or desktop application screen shot 801 showing a sender's end of the app usage 802 803. The single screen shot is split from the sender's view point of choosing a particular user from a list of possible receivers 803 804 812 813. The second juxtaposed screen is for the chosen receiver 802, where the entire finance related chat session is shown 805 806 807 808 809 811. It includes informal communication 805 807, send and received news cards 806 814, windows to add comments 811 and send it further down the contact list all information related to financial news cards. The received comments are also shown. If one is chosen 811 810, a superimposed window on the chosen stock also appears 808. The figure is illustrative of the use of the app from a sender's standpoint.

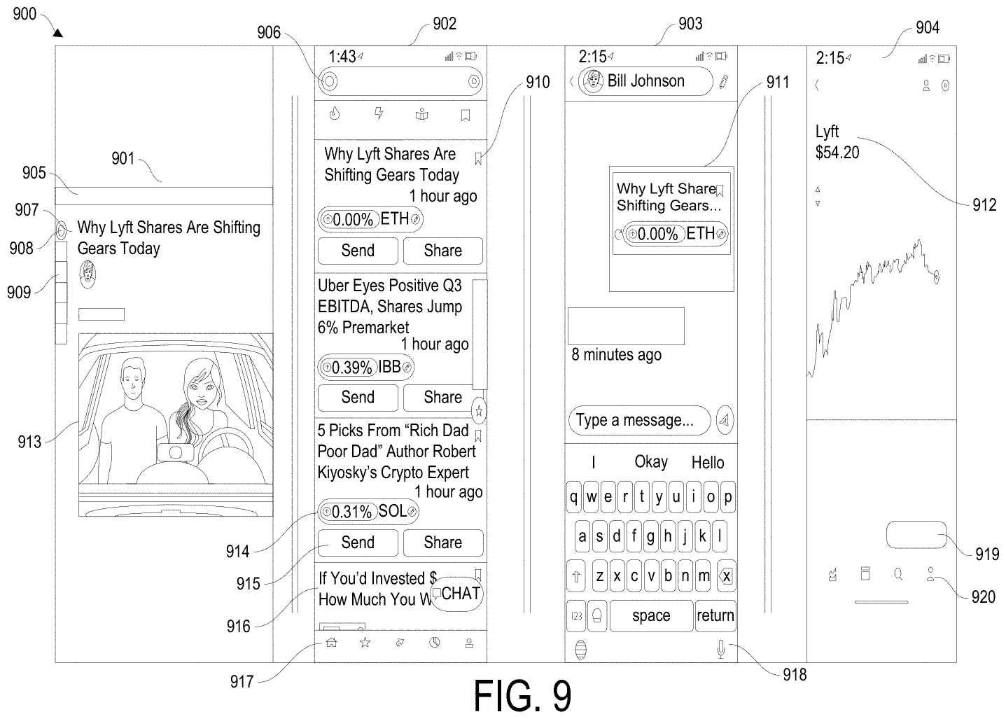

FIG. 9 900 is an exemplary illustration, in one embodiment, of a mobile or desktop application flow 901 902 903 904, which is exemplified with four windows which are juxtaposed side by side 901 902 903 904. The first window shows the chat news extracted or sent from accessing financial websites, with LYFT being the exemplary stock 901. Through “SHARE or SEND, the proposed mobile or desktop application is invoked to be able to compose financial news cards 902. A plurality of financial news cards are formed, each of which gives a share and send mechanism to chosen users from the contact list. 910 914 915 916 917. Ability to book mark and invoke a chat session is provided. 910. From this screen, the choice of a user invokes the third window for a named user. 903 The sent news cards are shown as received, window is provided to type a message, and a keyboard invoked to be able to access and add new stock or other financial instrument symbols 911 918. The user then invokes the stock details through trading website of choice to obtain a window of information related to the stock. 904 912 919 920. The first two are windows from the sender's perspective 901 902 and the last two in the flow are from a receiver's perspective 903 904. There is a mechanism to push the news from external website to intended application. This is the way financial news is crowd sourced. 908.

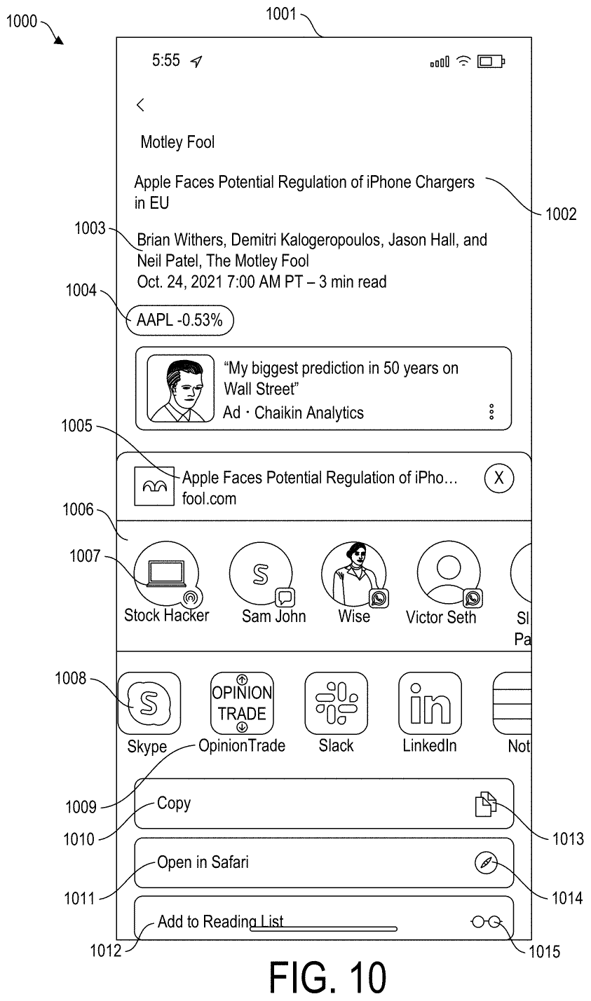

FIG. 10 1000 is an exemplary illustration, in one embodiment, of a mobile or desktop application screenshot 1001. A standard desktop application or mobile screen shot is shown, with financial news 1005 displayed from the financial news sites 1001 1002 1003 1004. As a top level option, all users list is displayed with the availability shown whether on phone 1006, WhatsApp, another chat etc 1007. Also a series of applications are shown to be displayed which includes the newly proposed app likely to be named “OpinionTrade.” 1008. Other applications like skype, slack, LinkedIn are displayed among others 1008. For any news, ability is provided to copy 1010, open in another web browser 1011 or add to a reading list to be read and worked on later if required 1012. Corresponding picture based choices are shown for reading later, opening in another browser. 1013 1014 1015. There is ability to share news from external websites and mobile applications to be shared at intended applications 1009. Financial news is crowdsourced this way also.

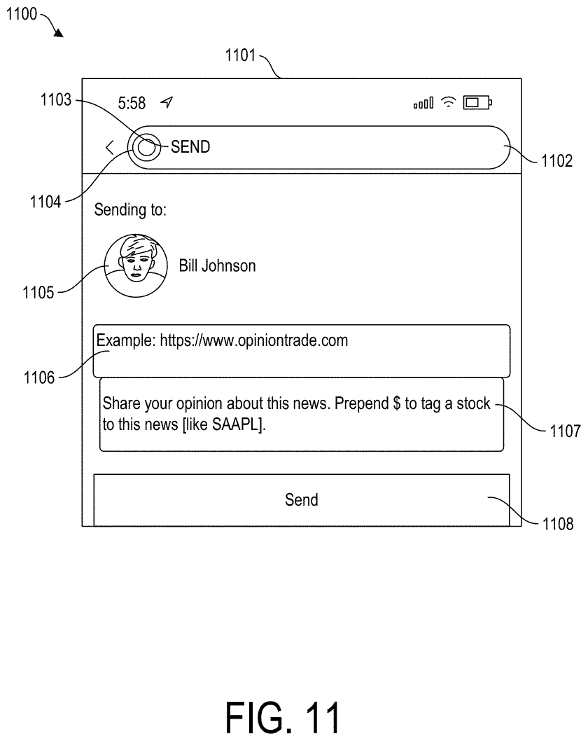

FIG. 11 1100 is an exemplary illustration, in one embodiment, of a mobile or desktop application screenshot 1101. This represents another embodiment of the use of the proposed app by the sender 1103. A user is chosen 1105, and financial news link information is shared for a company 1106. Option to share the news is provided and a “SEND” button provided 1107 1108. This embodiment represents a superimposed window for AAPL or other stock is not yet chosen by the sender and the keyboard superimposed window has not yet appeared. 1106 1107. Standard mobile or desktop icons for wireless connection, location and item are provided 1101. Full flexibility is provided to send appropriate information to the chosen receiver 1108 1103 1104 1105.

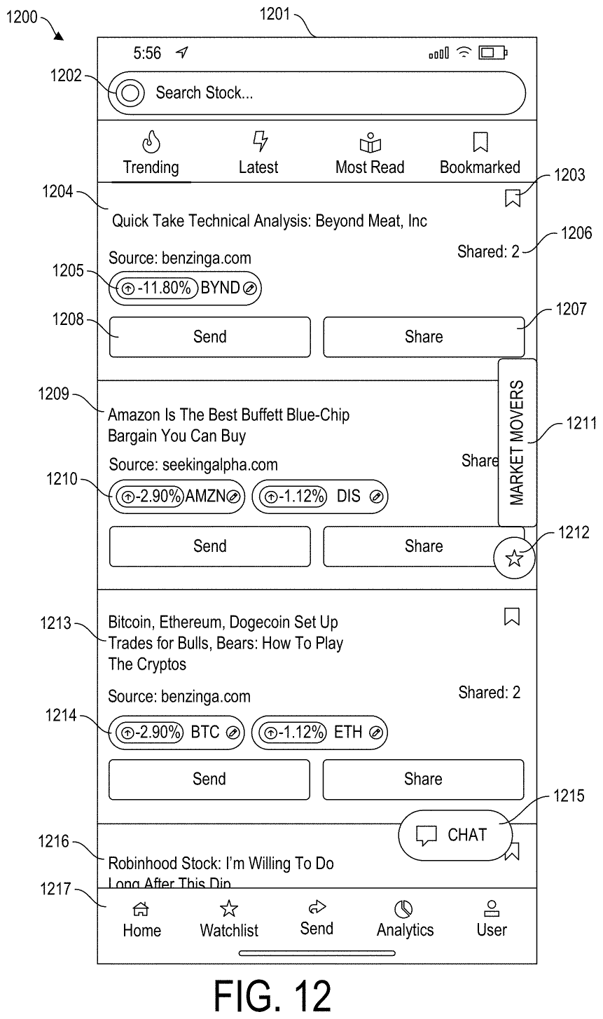

FIG. 12 1200 is an exemplary illustration, in one embodiment, of a mobile or desktop application screenshot 1201. This represents a screen shot to show a plurality of news cards assembled by the app, after having scanned, collected through newsfeed and crowdsourced the appropriate financial websites 1204 1209 1213 1216. Option to search a stock is provided and as an exemplary embodiment, trending news are used to form the financial news cards 1202 with option to bookmark 1203. A list of all trending news cards are shown which are scrollable 1204 1209 1213 1216. The financial news cards have stock symbol, send and share buttons and news title 1204 1205 1209 1210 1213 1214. Along with send and share button 1207, ability to start a chat session is also provided 1215. The app provides at the bottom to go to a home screen, get a watch list of stocks, a send screen shot, analytics to show analysis of stocks and invoking a user screen shot to search a user or users 1217. A favorite button is provided to store links to selected stocks 1212. Market sentiments are also provided 1211. Extracted investment news and stocks are based on machine learning and algorithm based ordering search and sort.

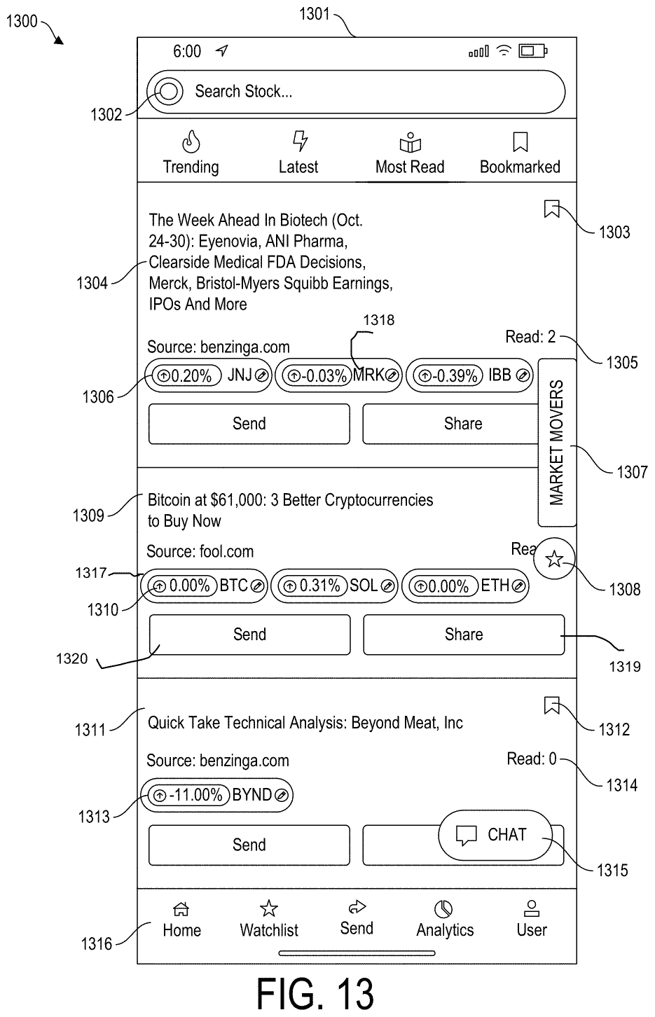

FIG. 13 1300 is an exemplary illustration, in one embodiment, of a mobile or desktop application screenshot 1301. This represents a screen shot to show a plurality of news cards assembled by the app, after having scanned or collected through news feed or crowdsourced the appropriate financial websites 1304 1309 1311. Option to search a stock is provided and as an exemplary embodiment, most read items are used to form the financial news cards 1302 with option to bookmark 1303. A list of all most read items news cards are shown which are scrollable 1304 1309 1311. The financial news cards have stock symbol, send and share buttons and news title 1304 1305 1309 1310 1313 1314. Along with send 1320 and share 1319 button market mover button 1307, ability to start a chat session is also provided 1315. The app provides at the bottom to go to a home screen, get a watch list of stocks, a send screen shot, analytics to show analysis of stocks and invoking a user screen shot to search a user or users 1316. A favorite button is provided to store links to selected stocks 1308. Extracted investment news and stocks are based on machine learning and algorithm based ordering search and sort.

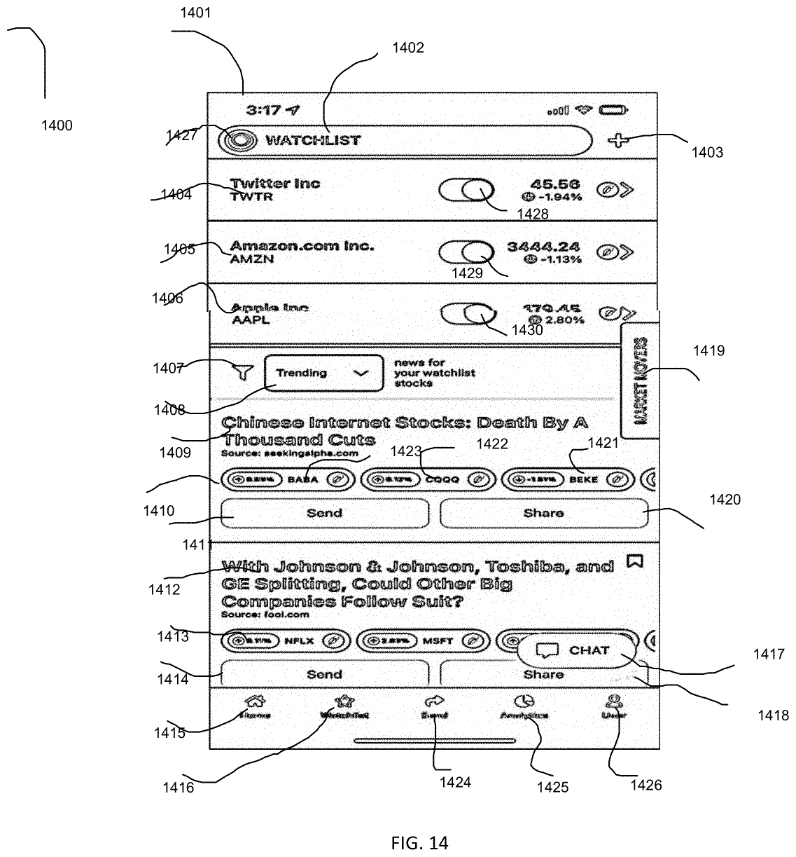

FIG. 14 1400 is an exemplary illustration, in one embodiment, of a mobile or desktop application screenshot 1401. This screen is exemplary representation when “WATCHLIST” 1402 is chosen from the watch list 1416. A list of stocks are displayed on the screen 1404 1405 1406, with the symbol, present value and ability to reach and effectuate a trade if so chosen. The screen 1401 optionally selects either trending, latest or most read news 1408, after organizing and constructing them to news cards as defined within 1409 1412. Each news card presents ability to send 1414 and share 1418. Stocks of interest are displayed on news cards 1421 1422 1423. There is ability to move to “Market Movers” 1419 screen. A filter capability is provided for the news cards 1407. Ability is also provided to move to chat window 1417. At the bottom of the screen, there is ability to return to home 1415, to pick watch list 1416, or go to send screen 1424, analytics 1425 or update user(s) 1426. A button of the app 1427 is shown on the watch list 1402 window with a “+” sign signifying ability to add stocks on the watch list 1403. An ability is provided to toggle news for a stock 1428 1429 1430.

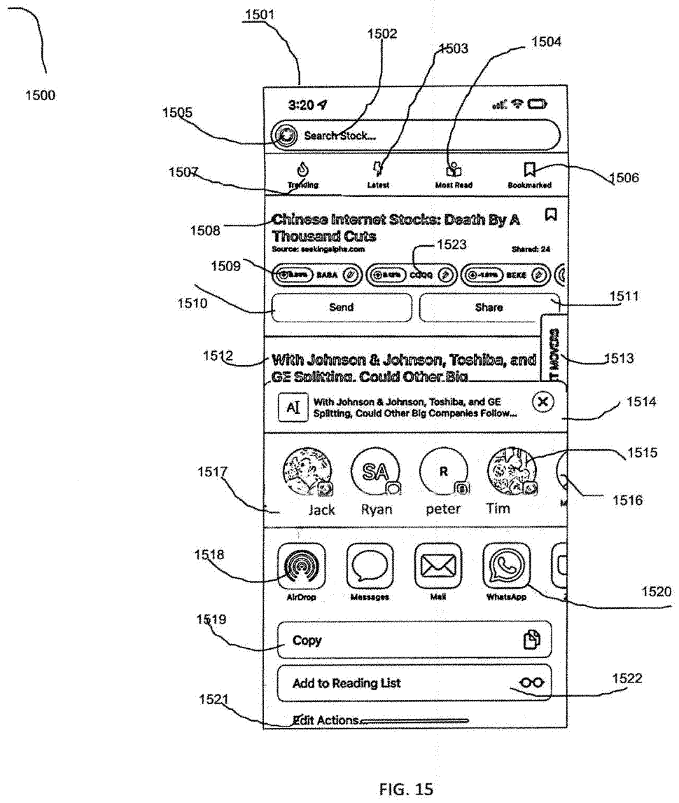

FIG. 15 1500 is an exemplary illustration, in one embodiment, of a mobile or desktop application screenshot 1501. It represents the “SHARE” screen 1501, when it is chosen from the news card in question 1511. Similar to other windows, the app button 1505 and the window identifier are shown 1502, Ability to search additional stocks is provided 1502. Ability to display news cards based on trending, latest, most read and book marked is provided 1507 1503 1504 1506. Based on one of the four choices, the news cards 1508 1512 are shown with stock symbol 1523 1509, its present value and the change from the market's last close 1523 1509. The news cards 1508 1512 provide ability to send 1510 and share 1511. A list of users 1517 is shown in a scrollable fashion within a windowlet (mini window), with users names displayed 1515 1516. Ability to share on various apps id provided with ability to scroll within a windowlet 1518, with apps of “AirDrop,” “Messaging or Texting,” “Email,” “WhatsApp” and others 1520. Ability to copy news cards 1519, addition to reading list is provided 1522, with option provided to user to be able to edit or change the action set 1521. An ability to move to “MarketMovers” 1513 screen is provided as well. Stock symbols are displayed and provide capability to immediately move to trading sites, if required 1523 1509.

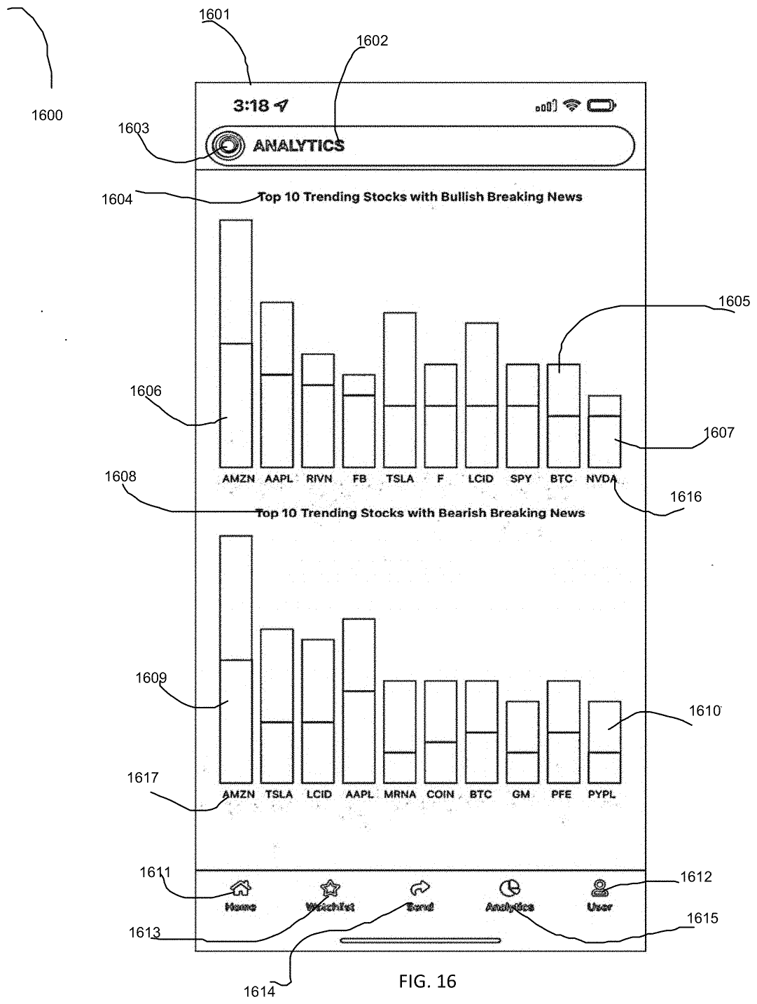

FIG. 16 1600 is an exemplary illustration, in one embodiment, of a mobile or desktop application screenshot 1601. It represents the “ANALYTICS” 1602 window screen when the same if chosen from the home window's bottom windowlet (mini window) 1615. An app button 1603 and window identifier are displayed 1602. Histograms 1606 1609 associated with a chosen set of stocks are displayed in negative 1610 and positive color 1606 codes. Among others, in one embodiment, up to ten stocks are chosen for top trending stocks 1604 1608, as well as whether news on them is bullish 1604 or bearish 1608. Ability to click on stock and access news cards is provided 1610 1609 1606. The news cards provide ability to share, send and move to trading sties to effectuate trade if required 1617 1616. At the bottom, the windowlet provides ability to go back to the home screen 1611, go to watch list 1613, go to send screen 1614, stay on analytics 1615 and or go to user selection screen 1612 with ability to group chat, single chat or send or share news cards.

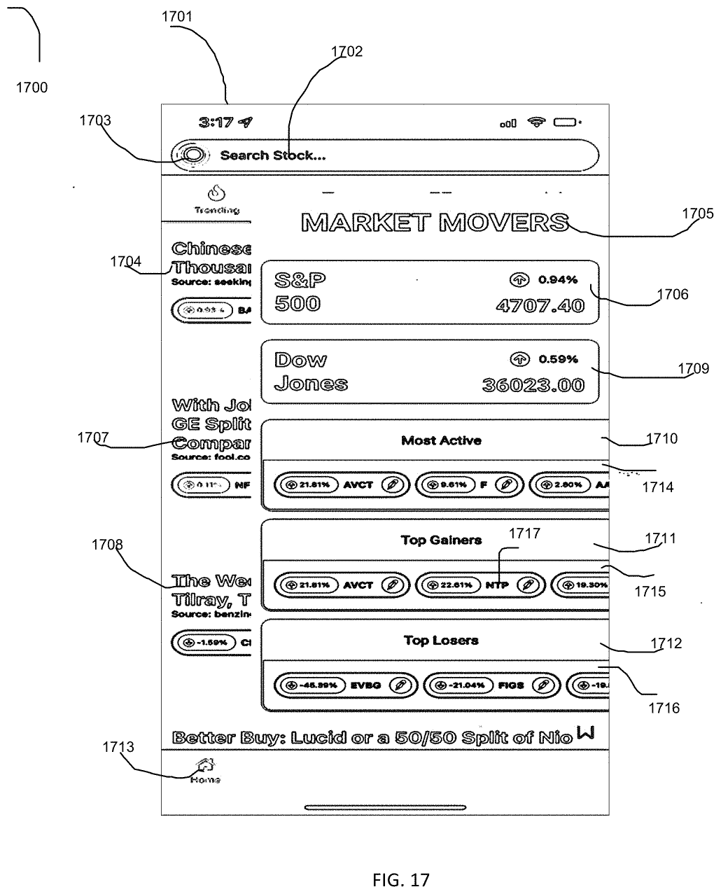

FIG. 17 1700 is an exemplary illustration, in one embodiment, of a mobile or desktop application screenshot 1701. It represents the “MARKETMOVERS” 1705 screen shot. App button 1703 and ability to search stocks is provided 1702. The news card screen shot is shown 1701 over which the MARKETMOVERS windowlet 1705 is superimposed. The news card provide trending, latest, most read or bookmarked stocks news 1704 1707 1708. That window also has an ability to take user to “MARKETMOVERS” window. The market movers window is superimposed 1705, showing current market for S & P 1706 and Dow Jones Industrial 1709 as an exemplary implementation, present value and change from last close. The market movers organizes a news card specific to most active stocks 1710, top gainers 1711 and top losers 1712. The stock list is a windowlet 1714 1715 1716, which is individually scrollable to be able to evaluate top certain number of these stocks. Each row displays the stock symbols to be able to move to trading sites of brokers or be able to immediately trade if so desired 1717. There is ability to go to trending, latest, most read news of that stock. Stock can also be added or removed from the watch list. The bottom window, similar to other windows, provides ability to go back to home screen 1713, display analytics, display watch list of stocks and move to single/or group chat session with a chosen set of users.

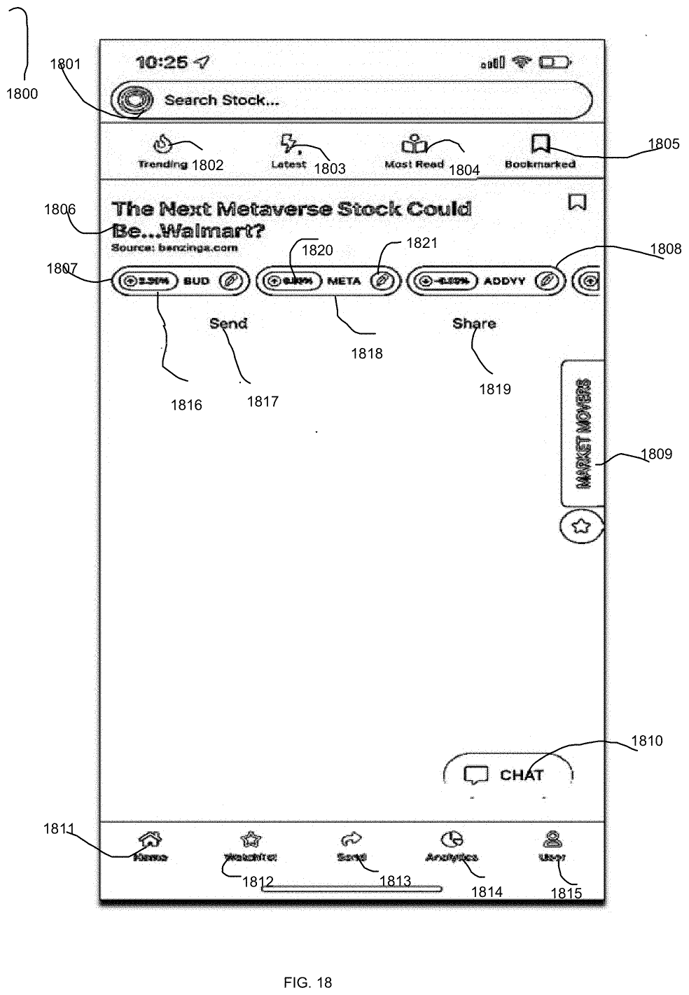

FIG. 18 1800 is an exemplary illustration, in one embodiment, of a mobile or desktop application screenshot 1801. This represents a screen shot to show a plurality of news cards assembled by the app, after having scanned, collected through newsfeed and crowdsourced the appropriate financial websites and then bookmarked. 1806 Option to search a stock is provided and as an exemplary embodiment. Bookmarked news cards are used to form the bookmarked screen 1805. A list of all bookmarked news cards are shown which are scrollable 1806. The financial news cards have stock symbol, send and share buttons and news title 1806 1807 1816 1817 1818 1819. Along with send and share button 1817 1819, ability to start a chat session is also provided 1810. The app provides at the bottom to go to a home screen, get a watch list of stocks, a send screen shot, analytics to show analysis of stocks and invoking a user screen shot to search a user or users 1811 1812 1813 1814 1815. A favorite button is provided to store links to selected stocks. Market sentiments are also provided. Extracted stocks are based on machine learning and algorithm based ordering search and sort. Market movers selection is provided 1809. Stock trading mechanism is provided with current valuation shown. 1820 1821.

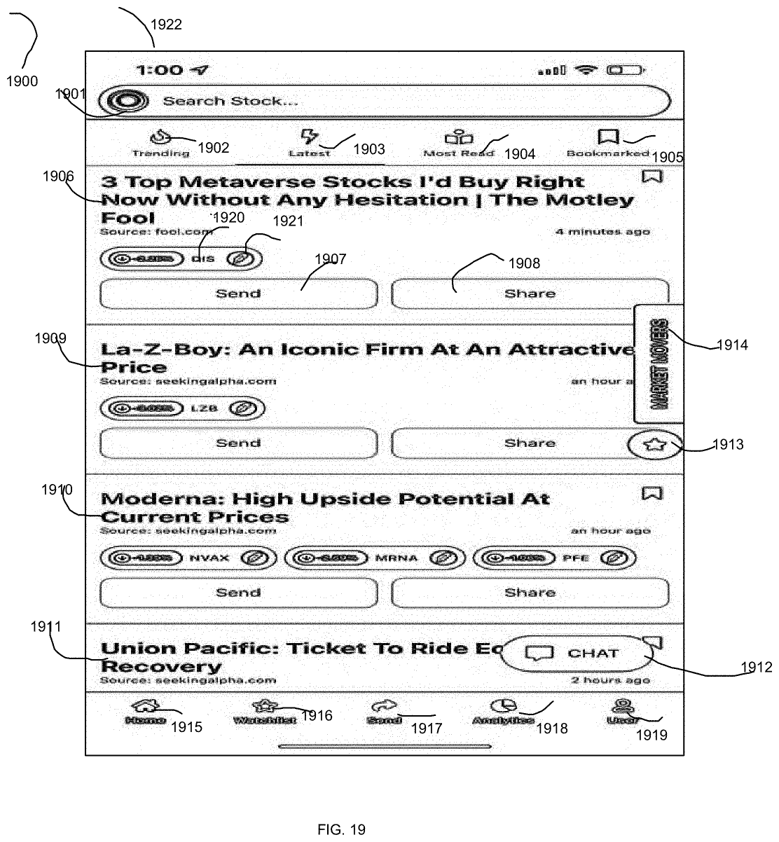

FIG. 19 1900 is an exemplary illustration, in one embodiment, of a mobile or desktop application screenshot 1922. This represents a screen shot to show a plurality of news cards assembled by the app, after having collected through newsfeed, crowd sourced and scanned the appropriate financial websites 1906 1909 1910 1911. Option to search a stock is provided and as an exemplary embodiment, “latest” are used to form the financial news cards 1903 with option to bookmark 1905. A list of latest items news cards are shown which are scrollable 1906 1909 1910 1911. The financial news cards have stock symbol, send and share buttons and news title 1920 1921 1907 1908. Along with send 1907 and share 1908 button market mover button 1914, ability to start a chat session is also provided 1912. The app provides at the bottom to go to a home screen, get a watch list of stocks, a send screen shot, analytics to show analysis of stocks and invoking a user screen shot to search a user or users 1915 1916 1917 1918 1919. A favorite button is provided to store links to selected stocks 1913. Extracted stocks and investment news are based on machine learning and algorithm based ordering search and sort.

Embodiments as described herein as a framework system are exemplary. The examples provided above are illustrative only and are not intended to be limiting. One skilled in the art may readily devise other systems consistent with the disclosed embodiments which are intended to be within the scope of this disclosure. Although the present invention has been explained in relation to its preferred embodiment of financial trading instruments (stock as an exemplary instance), it is to be understood that many other possible modifications and variations can be made without departing from the spirit and scope of the invention as herein described.

What is claimed is:

1. A financial investment trading framework system, comprising:
a plurality of computer systems with memory, peripherals, fixed and removable media, processor with a user interface connected through buses or networks;
a social network dedicated to investment financial news sharing, overlaid over the network, running programs or applications with a plurality of subscribers, over the computer systems and;
enabling the subscriber to send and share a plurality of financial news cards over the social network to be intelligently informed and to invoke trading systems from within the framework and to effectuate a trade of stocks, bonds and a plurality of other security instruments.

2. The financial investment trading framework system of claim 1 where the financial news cards and messages are sent or shared with and notified to subscribers on the social network.

3. The financial investment trading framework system of claim 1 where the financial news cards and messages are sent to or shared with a single or group chat session.

4. The financial investment trading system of claim 1 with ability to extract crowdsourced, most read, latest, trending and bookmarked security instruments from the computer network or other shared databases and synthesize them in a plurality of financial news cards.

5. The financial investment trading system of claim 1 with ability to perform analytical analysis display statistically, a plurality of security instruments including stocks, trending, latest, most read or shared news.

6. The financial investment trading system of claim 1 with ability to extract market moving security instruments, including stocks, in terms of top gainers and top losers.

7. The financial investment trading system of claim 1 where select and sorting of stocks and investment news is done through machine learning.

8. A financial investment trading framework apparatus, comprising:
a plurality of computer systems with memory, peripherals, fixed and removable media, processor with a user interface connected through buses or networks and;
a social network dedicated to financial news sharing overlaid over the network, running programs or applications with a plurality of subscribers, over the computer systems;
enabling ability to the subscriber to send and share a plurality of financial news cards over the social network to be intelligently informed and to invoke trading systems from within the framework and to effectuate a trade of stocks, bonds a plurality of other security instruments.

9. The financial investment trading framework apparatus of claim 8 where the financial news cards and messages are sent or shared with and notified to subscribers on the social network.

10. The financial investment trading framework apparatus of claim 8 where the financial news cards and messages are sent to or shared with a single or group chat session.

11. The financial investment trading apparatus of claim 8 with ability to extract crowdsourced, most read, latest trending and bookmarked security instruments from the computer network or other shared databases and synthesize them in a plurality of financial news cards.

12. The financial investment trading apparatus of claim 8 with ability to perform analytical analysis display statistically, a plurality of security instruments including stocks, trending, latest, most read or shared news.

13. The financial investment trading apparatus of claim 8 with ability to extract market moving security instruments, including stocks, in terms of top gainers and top losers.

14. The financial investment trading apparatus of claim 8 where select and sorting of investment news and stocks is done through machine learning.

15. A financial investment trading framework method, comprising:
a plurality of computer systems with memory, peripherals, fixed and removable media, processor with a user interface connected through buses or networks and;
a social network dedicated to financial news sharing overlaid over the network, running programs or applications with a plurality of subscribers, over the computer systems;
enabling ability to the subscriber to send and share a plurality of financial news cards over the social network to be intelligently informed and to invoke trading systems from within the framework and to effectuate a trade of stocks, bonds a plurality of other security instruments.

16. The financial investment trading framework method of claim 15 where the financial news cards and messages are sent or shared with and notified to subscribers on the social network.

17. The financial investment trading framework method of claim 15 where the financial news cards and messages are sent to or shared with a single or group chat session.

18. The financial investment trading method of claim 15 with ability to extract crowdsourced, most read, latest, trending and bookmarked security instruments from the computer network or other shared databases and synthesize them in a plurality of financial news cards.

19. The financial investment trading method of claim 15 with ability to perform analytical analysis display statistically, a plurality of security instruments including stocks, trending, latest, most read or shared news.

20. The financial investment trading method of claim 15 with ability to extract market moving security instruments, including stocks, in terms of top gainers and top losers.

21. The financial investment trading method of claim 15 where select and sorting of investment news and stocks is done through machine learning.
